(19) United States
(12) Patent Application Publication
(10) Pub. No.: US 2005/0208298 A1
(43) Pub. Date: Sep. 22, 2005

(54) PSA tape for medical diagnostic strips

(75) Inventors: Ingo Neubert, Norderstedt (DE); Bernd Bunde, Apensen (DE)

Correspondence Address: Norris, McLaughlin & Marcus P.A., 18th Floor, 875 Third Avenue, New York, NY, 10022, US

(73) Assignee: tesa Aktiengesellschaft, Hamburg (DE)

(21) Appl. No.: 10/998,888

(22) Filed: Nov. 29, 2004

(30) Foreign Application Priority Data
Mar. 18, 2004 (DE) 10 2004 013 699.8

(51) Int. Cl. B32B 7/12

(52) U.S. Cl. 428/354; 428/355 AC

(57) ABSTRACT

Pressure-sensitive adhesive tape for medical diagnostic strips used to analyze biological fluids, the tape comprising a carrier material coated on one or both sides with not more than 20 g/m², preferably not more than 15 g/m², per side, of a pressure-sensitive adhesive, where the shear strength of the pressure-sensitive adhesive at 25° C. and 70° C. under a weight load of 1000 g is greater than 10 000 min and the polymer or polymers of the pressure sensitive adhesive has or have a K value of greater than 55 Pa*s.

The present invention relates to a single-sided or double-sided pressure-sensitive adhesive (PSA) tape which can be used for constructing medical diagnostic strips for biological fluids.

In modern medical diagnosis, strips referred to as diagnostic test strips are being used for an increasingly large number of analytical test strips. These diagnostic test strips can be used, for example, to determine the level of glucose, cholesterol, proteins, ketones, phenylalanine or enzymes in biological fluids such as blood, saliva and urine.

The most frequently encountered application is the determination and monitoring of blood sugar level among diabetics. Roughly 175 million people worldwide suffer from Diabetes mellitus type 1 and type 2. The trend in this condition is rising.

Many sufferers from this incurable disease monitor their blood sugar level up to 5 times a day in order to obtain the best match between the dosage of the medication (insulin) and the consumption of food, since an excessive blood sugar level inevitably makes health-related damage likely. Hitherto diabetics relied on the support of medical staff in order to determine the blood sugar level. To simplify the monitoring of the blood sugar level a test was developed which enables the diabetic to determine his or her blood sugar level with a minimum of effort and without reliance on medical staff.

To determine the blood sugar level the tester has to apply a drop of blood to a diagnostic test strip. During this procedure the diagnostic test strip is located in a read device or evaluation device. Following a reaction time or response time the evaluation device indicates the current blood sugar level. Read or evaluation devices of this kind are described for example in U.S. Pat. No. 5,304,468 A, EP 1 225 448 A1 and WO 03/08091 A1.

With this test, the many diabetics can be given some quality of life, since they are less dependent on hospitals and surgeries. Additionally, medicinal products can be given in a more precise dose.

One of the first patents in the technical field of test strips appeared back in 1964. U.S. Pat. No. 1,073,596 A describes a diagnostic test and the test strips for analyzing biological body fluids, especially for determining blood sugar. The diagnostic test functions via the determination of a colour change which is triggered by an enzyme reaction. As regards the construction of the test strip there is already a description of the use of a household adhesive or of the adhesive tape Scotch ® 464.

Determining a change in the concentration of a dye (calorimetric method) is still a method used today in the determination of blood sugar using diagnostic test strips. The enzyme glucose oxidase/peroxidase reacts with the blood sugar. The hydrogen peroxide formed then reacts with the indicator—o-toluidine, for example—which leads to a colour reaction. This colour change can be monitored by colorimetric methods. The degree of change in colour is directly proportional to the concentration of blood sugar. In this case the enzyme is located on a woven fabric.

This method is described for example in EP 0 451 981 A1 and WO 93/03673 A1.

The modern development of diagnostic test strips aims to reduce the measurement time between the application of the blood to the test strip and the appearance of the result. In U.S. Pat. No. 4,787,398 A a relatively long measurement time of 60 s is still described.

One of the ways in which the measuring time is reduced is by the use of hydrophilicized woven or nonwoven fabrics, as in U.S. Pat. No. 6,555,061 B, in order to transport the blood more quickly to the measuring area (enzyme). The measuring method is identical with that described in EP 0 451 981 A1. In the construction of the diagnostic strips a double-sided adhesive tape Scotch ® 415 is used.

A further example of a strip is described in US 2002/0102739 A. There, blood transport of 1.0 mm/s is achieved through a plasma-treated woven fabric (wick).

Further disclosures of diagnostic test strips can be found in U.S. D 450,854 S, U.S. Pat. No. 5,304,468 A and U.S. Pat. No. 5,709,837 A. In the last two citations a hot-melt adhesive, which becomes tacky as a result of heat being supplied, is used for the construction of the test strip.

WO 03/008933 A1 describes a diagnostic test strip which is constructed from a membrane that chromatographs the blood, thereby allowing individual blood constituents to be analyzed separately. Example 1 mentions the use of a double-sided adhesive tape with PET backing, though no further details of this tape are described.

An onward development from the colorimetric measurement technique is the electrical determination of the change in oxidation potential of an electrode coated with the enzyme. This method and a corresponding diagnostic test strip are described in WO 01/67099 A1. The diagnostic strip is constructed by printing various functional coats, such as electrical conductors, enzyme and hot-melt adhesive, onto the base material, which is of polyester, for example. Subsequently a hydrophilic film is laminated on by thermal activation of the adhesive. The purpose of the hydrophilic film is to transport the blood to the measuring cell.

With this construction there is no need for woven or nonwoven fabric to transport the blood. The advantage of this construction and the advantage of the new measuring technique is that the blood sugar level can be measured with a very much smaller volume of blood, around 5 to 10 μl, and in a shorter measuring time.

WO 03/067252 A1 likewise discloses a diagnostic test for determining the blood sugar level, based on measuring the electrical potential of an electrode coated with glucose oxidase. The construction of the diagnostic test strip is very similar to that described in WO 01/67099 A1. Here again a hotmelt adhesive is preferably used with a coatweight of from 10 to 50 g/m², preferably 20 to 30 g/m². One possible alternative to forming the strip is again to use a pressure-sensitive adhesive tape.

The diagnostic strips described are produced in the majority of cases by means of a discontinuous sequence of coating and laminating steps. The base material used is a film 300 to 500 μm thick and composed of polyvinyl chloride, polyester or polycarbonate, with dimensions of approximately 400×400 mm. After the coating and laminating steps this film is first cut into narrower bands with dimensions of around 400×40 mm. In a further cutting operation, finally, these bands are cut to form the diagnostic test strips. One band produces around 70 diagnostic strips.

The cutting, or slitting, of the narrow bands to form the diagnostic strips takes place at very high cycle rates of 100 bands per second using cutting machines which come, for example, from Siebler GmbH or Kinematik Inc. In the course of this cutting operation the cuffing tool becomes contaminated with residues of adhesive after just a short time in the case of those products which are constructed using a commercially customary PSA tape. This contamination after just a few hours has already reached a level where the blades, drive units and guide rails of the cutting machine must be changed over wholesale and cleaned. This gives rise to considerable maintenance and downtime costs. The cuffing tools have to be cleaned at approximately every 4000 to 8000 cuts.

The residues of adhesive mentioned are attributable to the commercially customary self-adhesive tapes employed. The use of non-self-adhesive hot-melt adhesives or heat-sealing adhesives such as those based, for example, on polyamides, polyisobutylene, polyvinylbutyral, polyesters, poly(ether sulphone)s, ethylene/ethyl acrylate copolymers or ethylene/vinyl acetate copolymers achieves a significant lengthening in the cleaning intervals. In this case the cutting tools need only be cleaned every 8000 cuts.

When hot-melt adhesives are used, however, considerable disadvantages are observed in the construction of the diagnostic test strips. Activation of the hot-melt adhesives requires pressure and temperatures of at least 80° C. Under these conditions on the one hand there is a risk of thermal damage to the enzyme layer and to one of the woven or nonwoven fabrics used, and on the other hand it is impossible to realize a uniform distance between the functional layers such as base film, woven fabric and outer film of the diagnostic test strip. The distance between the functional layers determines the blood volume which is used for the measurement. If there are fluctuations in the blood volume as a result of an excessive range of fluctuation in the distance between the functional layers across—for example—different batches of test strips it is impossible to determine the blood sugar level reliably.

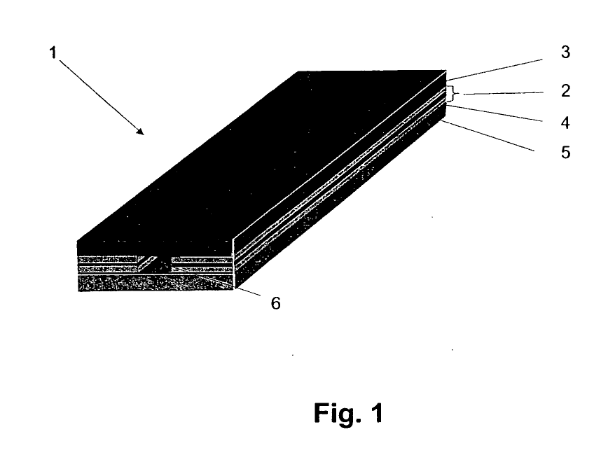

One exemplary construction of a medical diagnostic test strip is depicted diagrammatically in FIG. 1.

The test strip 1 is composed of a plurality of individual layers 2, 3, 4 and 5.

On top of the 500 μm PET base material 5 there are a plurality of functional layers 4, printed on over the full area and composed for example of conductive materials or enzymes. This functional layer 4 is connected to the hydrophilic top tape 3, in this case a PET film 100 μm thick and hydrophilicized on one side, by means for example of a dyecut of a double-sided PSA tape 2. The PSA tape 2 itself has two PSA layers, composed preferably of a polyacrylate PSA, with a PET carrier between them. The PSA tape dyecut 2 forms a channel 6, which is needed to transport the biological test fluid under measurement—blood, for example—to the measuring cell.

It is an object of the present invention to provide a pressure-sensitive adhesive tape in web form which is suitable for constructing diagnostic test strips, meeting the requirements imposed on such strips, and which specifically in the cutting operation of the diagnostic test strips leads to a considerable reduction in the residues of adhesive on the cutting tools.

This object is achieved by means of a pressure-sensitive adhesive tape as specified in the main claim. The dependent claims provide advantageous developments of the subject-matter of the invention. The invention further embraces the possibility of use of the pressure-sensitive adhesive tape of the invention in medical diagnostic strips for biological fluids.

The invention accordingly provides a pressure-sensitive adhesive tape for medical diagnostic strips used to analyze biological fluids, the tape comprising a carrier material coated on one or both sides with not more than 20 g/m², preferably not more than 15 g/m², per side, of a pressure-sensitive adhesive.

The shear strength of the pressure-sensitive adhesive at 25° C. and 70° C. under a weight load of 1000 g is greater than 10 000 min and the polymer or polymers of the pressure-sensitive adhesive has or have a K value of greater than 55 Pa*s.

The characteristic quality of the PSA tape of the invention is the use of a PSA of high cohesion or shear strength in conjunction with high bond strength with a thin adhesive layer of not more than 20 g/m², preferably not more than 15 g/m². This combination of qualities allows the object of the invention, the considerable reduction in the residues of adhesive on the cutting tool in the operation of cutting the diagnostic test strips, to be achieved. The high shear strength of the PSA is reflected in a high polymer or copolymer K value of greater than 55 Pa*s, preferably greater than 60 Pa*s, and in a high shear strength of greater than 10 000 min at 70° C. under a weight load of 1000 g.

The high shear strength of the PSA is likewise reflected in the microshear travel investigation. This is a method which allows the shear strength of PSAs to be investigated within a short measuring time. The microshear travel μS of the PSA tape after 15 minutes at 40° C. under a load of 500 g is preferably less than 100 μm, more preferably less than 60 μm, very preferably less than 30 μm and most preferably less than 10 μm.

The ratio μS2/μS1, as a measure of the elasticity of the PSA of the PSA tape of the invention, is preferably less than 0.3 and more preferably less than 0.2.

Likewise advantageous is a polymer or copolymer dynamic glass transition temperature of from −10° C. to 15° C. and preferably from −6° C. to 4° C.

Surprisingly and unforeseeably for the skilled person a PSA tape having the properties according to the invention is able to meet the contradictory requirements of high bond strength to the base material of the diagnostic test strips in conjunction with low tack with respect to the cutting tools.

Polymers suitable for preparing the PSA of the PSA tape of the invention having the described properties include copolymers or copolymer mixtures of acrylate monomers or styrene block copolymers with, for example, ethylene, propylene, butylene, butadiene, hexene and/or hexadiene comonomers.

The PSA of the PSA tape of the invention is composed in the preferred embodiment of one or more copolymers of at least the following monomers

c1) 79% to 100% by weight by weight of acrylic esters and/or methacrylic esters and/or their free acids with the following formula
CH₂═CH(R₁)(COOR₂),
where R₁=H and/or CH₃ and R₂=H and/or alkyl chains having 1 to 30 carbon atoms.

Here as well it is possible for the parent monomer mixture to be admixed with, as a further component,

c2) up to 30% by weight of olefinically unsaturated monomers containing functional groups.

In one very preferred version the monomers used for c1) are acrylic monomers comprising acrylic and methacrylic esters with alkyl groups consisting of 4 to 14 carbon atoms, preferably 4 to 9 carbon atoms. Specific examples, without wishing to be restricted by this recitation, include n-butyl acrylate, n-pentyl acrylate, n-hexyl acrylate, n-heptyl acrylate, n-octyl acrylate, n-nonyl acrylate, lauryl acrylate, stearyl acrylate, behenyl acrylate, and branched isomers thereof such as t-butyl acrylate and 2-ethylhexyl acrylate, for example.

Further classes of compound which may likewise be added in small amounts under c1) are methyl methacrylates, cyclohexyl methacrylates, isobomyl acrylate and Isobornyl methacrylate.

In one very preferred version the monomers used for c2) are vinyl esters, vinyl ethers, vinyl halides, vinylidene halides, vinyl compounds containing aromatic rings and heterocycles in α position.

Here again a number of examples may be given, without the recitation being regarded as being conclusive:
vinyl acetate, vinylformamide, vinylpyridine, ethyl vinyl ether, vinyl chloride, vinylidene chloride and acrylonitrile.

In a further very preferred version monomers used for c2) include monomers containing the following functional groups:
hydroxyl, carboxyl, epoxy, acid amide, isocyanato or amino groups.

In one advantageous variant use is made for c2) of acrylic monomers corresponding to the general formula
CH₂═CH(R₁)(COOR₃),
where R₁=H or CH₃ and the radical R₃ consists of or comprises a functional group which supports subsequent UV crosslinking of the PSA and which, for example, in one particularly preferred version, possesses an H-donor action.

Particularly preferred examples of component c2) are hydroxyethyl acrylate, hydroxypropyl acrylate, hydroxyethyl methacrylate, hydroxypropyl methacrylate, allyl alcohol, maleic anhydride, itaconic anhydride, itaconic acid, acrylamide and glyceridyl methacrylate, benzyl acrylate, benzyl methacrylate, phenyl acrylate, phenyl methacrylate, t-butylphenyl acrylate, t-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate, cyanoethyl methacrylate, cyanoethyl acrylate, glyceryl methacrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide, vinylacetic acid, tetrahydrofurfuryl acrylate, β-acryloyloxypropionic acid, trichloroacrylic acid, fumaric acid, crotonic acid, aconitic acid and dimethylacrylic acid, this recitation not being conclusive.

In a further preferred version use is made for component c2) of aromatic vinyl compounds, where the aromatic nuclei are preferably C₄ to C₁₈ and may also include heteroatoms. Particularly preferred examples are styrene, 4-vinylpyridine, N-vinylphthalimide, methylstyrene, 3,4-dimethoxystyrene and 4-vinylbenzoic acid, this recitation not being conclusive.

For the polymerization the monomers are in turn chosen such that the resulting polymers can be used as industrial PSAs, and especially such that the resulting polymers possess PSA properties as set out in the “Handbook of Pressure Sensitive Adhesive Technology” by Donatas Satas (van Nostrand, N.Y. 1989). For the PSA the static glass transition temperature of the resulting polymer is advantageously between −10 and 15° C. and more preferably between −6 and 4° C.

In order to prepare the polyacrylate PSAs it is advantageous to carry out conventional radical polymerizations or controlled radical polymerizations. For the polymerizations proceeding by a radical mechanism it is preferred to use initiator systems which additionally comprise further radical initiators for the polymerization, especially thermally decomposing, radical-forming azo or peroxo initiators. In principle, however, any customary initiators that are familiar to the skilled person for acrylates are suitable. The production of C-centred radicals is described in Houben Weyl, Methoden der Organischen Chemie, Vol. E 19a, pages 60 to 147. These methods are preferentially employed analogously.

Examples of radical sources are peroxides, hydroperoxides and azo compounds; some examples that may be mentioned of typical radical initiators include potassium peroxodisulphate, dibenzoyl peroxide, cumene hydroperoxide, cyclohexanone peroxide, di-t-butyl peroxide, azodiisobutyronitrile, cyclohexylsulphonyl acetyl peroxide, diisopropyl percarbonate, t-butyl peroctoate and benzpinacol.

The average molecular weights Mₙ of the PSAs formed in the course of the radical polymerization are very preferably chosen such as to be situated within a range from 20 000 to 2 000 000 g/mol; specifically for further use as hot-melt PSAs pressure-sensitive adhesives are prepared having average molecular weights Mₙ of from 100 000 to 500 000 g/mol. The average molecular weight is determined by size exclusion chromatography (SEC) or matrix-assisted laser-desorption/ionization-mass spectrometry (MALDI-MS).

The polymerization can be carried out in bulk (without solvent), in the presence of one or more organic solvents, in the presence of water, or in mixtures of organic solvents and water. The aim is to minimize the amount of solvent used. Suitable organic solvents are simple alkanes (for example hexane, heptane, octane, isooctane), aromatic hydrocarbons (for example benzene, toluene, xylene), esters (for example ethyl, propyl, butyl or hexyl acetate), halogenated hydrocarbons (for example chlorobenzene), alkanols (for example methanol, ethanol, ethylene glycol, ethylene glycol monomethyl ether) and ethers (for example diethyl ether, dibutyl ether) or mixtures thereof.

A water-miscible or hydrophilic cosolvent may be added to the aqueous polymerization reactions in order to ensure that during monomer conversion the reaction mixture is in the form of a homogeneous phase. Cosolvents which can be used with advantage for the present invention are selected from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulphides, sulphoxides, sulphones, alcohol derivatives, hydroxy ether derivatives, amino alcohols, ketones and the like, and derivatives and mixtures thereof.

In an advantageous procedure, radical stabilization is carried out using nitroxides of the type (NIT 1) or (NIT 2): 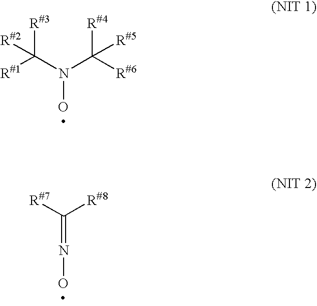
where R^{#1}, R^{#2}, R^{#3}, R^{#4}, R^{#5}, R^{#6}, R^{#7} and R^{#8} denote independently of one another the following compounds or atoms:

i) halides, such as chlorine, bromine or iodine, for example;

ii) linear, branched, cyclic and heterocyclic hydrocarbons having 1 to 20 carbon atoms, which may be saturated, unsaturated or aromatic;

iii) esters —COOR^{#9}, alkoxides —OR^{#10} and/or phosphonates —PO(OR^{#11})₂, where R^{#9}, R^{#10} and/or R^{#11} are radicals from group ii).

Compounds of the structure (NIT 1) or (NIT 2) may also be attached to polymer chains of any kind (primarily such that at least one of the abovementioned radicals constitutes a polymer chain of this kind) and may therefore be used to construct the block copolymers, as macroradicals or macroregulators.

A string of further polymerization methods by which the polyacrylate PSA may be prepared in an alternative procedure are known from the prior art.

U.S. Pat. No. 4,581,429 A discloses a controlled-growth radical polymerization process which uses as its initiator a compound of the formula R′R″N—O—Y, in which Y is a free radical species which is able to polymerize unsaturated monomers. The conversion rates of the reactions, however, are generally low. A particular problem is the polymerization of acrylates, which takes place only with very low yields and molar masses.

WO 98/13392 A1 describes open-chain alkoxyamine compounds which have a symmetrical substitution pattern.

EP 0 735 052 A1 discloses a process for preparing thermoplastic elastomers having narrow molar mass distributions.

WO 96/24620 A1 describes a polymerization process in which very specific radical compounds, such as phosphorus-containing nitroxides based on imidazolidine, for example, are used.

WO 98/44008 A1 discloses specific nitroxyls which are based on morpholines, piperazinones and piperazinediones.

DE 199 49 352 A1 describes heterocyclic alkoxyamines as regulators in controlled-growth radical polymerizations. Corresponding ongoing developments of the alkoxyamines or of the corresponding free nitroxides improve the efficiency for the preparation of polyacrylates (Hawker, paper given to the National Meeting of the American Chemical Society, spring 1997; Husemann, paper given to the IUPAC World Polymer Meeting 1998, Gold Coast).

As a further controlled polymerization method, Atom Transfer Radical Polymerization (ATRP) can be used advantageously to synthesize the block copolymers, in which case the initiator used preferably comprises monofunctional or difunctional secondary or tertiary halides and, for abstracting the halide(s), complexes of Cu, of Ni, of Fe, of Pd, of Pt, of Ru, of Os, of Rh, of Co, of Ir, of Ag or of Au (in accordance with EP 0 824 111 A1, EP 0 826 698 A1, EP 824 110 A1, EP 841 346 A1 or EP 850 957 A1). The various possibilities of ATRP are further described in U.S. Pat. No. 5,945,491 A, U.S. Pat. No. 5,854,364 A and U.S. Pat. No. 5,789,487 A.

With further advantage the polymer utilized in accordance with the invention can be prepared by way of anionic polymerization. In this case the reaction medium used preferably comprises inert solvents such as, for example, aliphatic and cycloaliphatic hydrocarbons or else aromatic hydrocarbons.

In addition it is possible to use difunctional initiators such as, for example, 1,1,4,4-tetraphenyl-1,4-dilithiobutane or 1,1,4,4-tetraphenyl-1,4-dilithioisobutane. Coinitiators may likewise be employed. Suitable coinitiators include lithium halides, alkali metal alkoxides or alkylaluminium compounds. In one very preferred version the ligands and coinitiators are chosen such that acrylate monomers such as, for example, n-butyl acrylate and 2-ethylhexyl acrylate can be polymerized directly and need not be generated in the polymer by a transesterification with the corresponding alcohol.

One very preferred preparation process conducted is a variant of the RAFT polymerization (reversible addition-fragmentation chain transfer polymerization). The polymerization process is shown in detail in, for example, WO 98/01478 A1 and WO 99/31144 A1. Suitable with particular advantage for the preparation are trithiocarbonates of the general structure R′″—S—C(S)—S—R′″ (Macromolecules 2000, 33, 243 to 245).

In conjunction with the abovementioned controlled-growth radical polymerizations it is preferred to use initiator systems which additionally comprise further radicals initiators for the polymerization, especially thermally decomposing, radical-forming azo or peroxo initiators. In principle, however, any customary initiators known for acrylates are suitable for this purpose. The production of C-centred radicals is described in Houben-Weyl, Methoden der Organischen Chemie, Vol. E19a, p. 60ff. These methods are employed preferentially.

Examples of radical sources are peroxides, hydroperoxides and azo compounds. A number of non-exclusive examples of typical radical initiators that may be mentioned here includes potassium peroxodisulphate, dibenzoyl peroxide, cumene hydroperoxide, cyclohexanone peroxide, cyclohexylsulphonyl acetyl peroxide, di-tert-butyl peroxide, azodiisobutyronitrile, diisopropylpercarbonate, tert-butyl peroctoate and benzpinacol. In one very preferred variant the radical initiator used is 1,1′-azobis(cyclohexylnitrile) (Vazo 88®, DuPont®) or 2,2-azobis(2-methylbutanenitrile) (Vazo 67®, DuPont®). In addition it is also possible to use radical sources which release radicals only under UV irradiation.

In the conventional RAFT process, polymerization is generally carried out only to low conversions (WO 98/01478 A1), in order to produce very narrow molecular weight distributions. As a result of the low conversions, however, these polymers cannot be used as PSAs and in particular not as hot-melt PSAs, since the high fraction of residual monomers adversely affects the technical adhesive properties, the residual monomers contaminate the solvent recyclate in the concentration process, and the corresponding self-adhesive tapes would exhibit a very high level of outgassing.

The internal strength (cohesion) of the polyacrylic PSA of the PSA tape of the invention is preferably increased by crosslinking. Crosslinking of the PSA increases the gel value and the microshear travel of the PSA tape of the invention. However there is also a reduction in the bond strength as a result of the crosslinking. For the crosslinking it is possible optionally to add compatible crosslinker substances to the acrylate PSAs. Particularly suitable crosslinkers include metal chelates, polyfunctional isocyanates, polyfunctional amines or polyfunctional alcohols. Crosslinking may advantageously take place thermally or by means of high-energy radiation (actinic radiation), in the latter case in particular by electron beams (EB) or, following the addition of suitable photoinitiators, by ultraviolet radiation. Preferred radiation-crosslinking substances are, for example, difunctional or polyfunctional acrylates or difunctional or polyfunctional urethane acrylates, difunctional or polyfunctional isocyanates or difunctional or polyfunctional epoxides. In this case, however, it is also possible to use any other difunctional or polyfunctional compounds which are familiar to the skilled person and are capable of crosslinking polyacrylates. Suitability as photoinitiators is possessed preferably by Norrish type I and type II cleaving compounds, some possible examples of both classes being benzophenone derivatives, acetophenone derivatives, benzile derivatives, benzoin derivatives, hydroxyalkylphenone derivatives, phenyl cyclohexyl ketone derivatives, anthraquinone derivatives, thioxanthone derivatives, triazine derivatives, or fluorenone derivatives, this recitation making no claim to completeness and instead being capable of expansion without an inventive step by the skilled person.

For advantageous development, no additives at all, such as tackifying resins or plasticizers, are added to the polyacrylate PSAs of the PSA tape of the invention. Although additives of this kind do increase the bond strength they also reduce considerably the shear strength of the PSA and so lead to residues of adhesive on the cutting tools during the operation of cutting the diagnostic test strips.

Additives such as fillers (for example fibres, carbon black, zinc oxide, titanium dioxide, chalk, solid or hollow glass spheres, microspheres of other materials, silica, silicates, nanoparticles), compounding agents and/or ageing inhibitors, in the form for example of primary and secondary antioxidants or in the form of light stabilizers, can be added to the PSA.

In summary the preferred embodiment of the PSA tape of the invention comprises a polyacrylate PSA which is manufactured by coextrusion or coating from the melt, from solution or from dispersion. Particular preference is given to comma bar coating of the polyacrylate PSA from a suitable solvent or solvent mixture.

It is advantageous to use a primer layer between carrier film and polyacrylate PSA in order to improve the adhesion of the PSA to the carrier film and so to prevent residues of adhesive on the cutting tool during the process of cutting the diagnostic test strips. Primers which can be used are the known dispersion and solvent systems, based for example on isoprene or butadiene rubber, cyclo rubber, polyvinyl chloride and/or polyvinyl dichloride homopolymers or copolymers. Isocyanate or epoxy resin additives enhance the adhesion and in some cases also increase the shear strength of the PSA. Physical surface treatments such as flaming, corona or plasma, or coextrusion layers, are likewise suitable for improving the adhesion.

In the case of the single-sided coating of the carrier film with the polyacrylate PSA it is possible for the reverse of the carrier film to have been coated with one of the known release agents (blended where appropriate with other polymers). Examples are stearyl compounds (for example polyvinyl stearylcarbamate, stearyl compounds of transition metals such as Cr or Zr, ureas formed from polyethylenimine and stearyl isocyanate, polysiloxanes (for example as a copolymer with polyurethanes or as a graft copolymer on polyolefin) and thermoplastic fluoropolymers. Stearyl stands as a synonym for all linear or branched alkyls or alkenyls having a C number of at least 10, such as octadecyl, for example.

Descriptions of the customary adhesives and also reverse-face coatings and primers can be found for example in the “Handbook of Pressure Sensitive Adhesive Technology”, D. Satas (3rd edition).

Carrier materials used for the pressure-sensitive adhesive tape are the customary carrier materials familiar to the skilled person, such as films of polyester, polyethylene, polypropylene, oriented polypropylene, or polyvinyl chloride, and with particular preference polyethylene terephthalate (PET) films. This recitation should not be understood as being conclusive; instead, further films are included in the scope of the invention.

The carrier material can be provided preferably on one or both sides with the polyacrylate PSA. The carrier film can be printed on one or both sides using the customary printing processes. The self-adhesive tape may likewise be laminated together with a commercially customary release film, which is usually composed of a base material of polyethylene, polypropylene, polyester or paper coated on one or both sides with polysiloxane.

For processing and use in a diagnostic test strip it can be of advantage if diecuts having a punched form suitable for the application are produced from the PSA tape of the invention.

The total thickness of the PSA tape without release film is preferably 20 to 150 μm, more preferably 50 to 100 μm.

With further preference the bond strength to steel is at least 1.5 and preferably 2.5 N/cm and/or the bond strength to PET is at least 0.5 and preferably 1.0 N/cm.

Important factors for the inventively preferred use of the PSA tape in a diagnostic test strip, besides the biological compatibility of the constituents with the biological test fluid and with the enzyme reaction, are the thickness tolerance and a low compressibility. Since the thickness of the PSA tape in the majority of diagnostic test strips determines the distance between the functional layers such as base film, woven fabric and cover film, and hence the volume of the biological test fluid in the test strips, correct measurement of, say, the blood sugar level is possible only by low compressibility and by a very good thickness tolerance.

### TEST METHODS

### K Value

The K value is a measure of the average molecule size of high polymers. The principle of the method is based on a determination of the relative solution viscosity by capillary viscometry. For this purpose the test substance is dissolved in toluene by shaking for half an hour to give a 1% strength solution. The flow time is measured at 25° C. in a Vogel-Ossag viscometer and from this measurement the relative viscosity of the sample solution is determined in relation to the viscosity of the pure solvent. The K value (K=1000 k) can be read off from tables in accordance with Fikentscher [P. E. Hinkamp, Polymer, 1967, 8, 381].

### Glass Transition

The dynamic glass transition of the PSA is determined by means of rheometrical investigation. A rheometer from the Ares range from the company TA is used. The glass transition temperature is the maximum of the tan δ (=G″/G′) plot and is determined at 10 rad/s.

### Gel Value

The solvent-free PSA samples were welded into a pouch of polyethylene nonwoven (Tyvek web). Soluble constituents are extracted with toluene over a period of three days, with the solvent changed daily. The gel value is determined from the difference between the sample weights before and after extraction, as a percentage of the weight fraction of the polymer which is not extractable with toluene.

### Bond Strength

The peel strength (bond strength) was tested in a method based on PSTC-1. A strip of the PSA tape, 2 cm wide, is adhered to the test substrate, such as a ground steel plate or a PET plate; this is done by applying the tape and running a 5 kg roller over it back and forth five times. The plate is clamped in and the self-adhesive strip is pulled by its free end in a tensile testing machine under a peel angle of 180° at a speed of 300 mm/min; the force required in order to pull the strip is measured. The results are reported in N/cm and are averaged over three measurements. All measurements were conducted at room temperature.

### Shear Withstand Times

The test was carried out along the lines of PSTC-7. A strip of the PSA tape, 1.3 cm wide, is adhered to a polished steel plaque over a length of 2 cm; this is done by applying the strip and using a 2 kg roller to roll over it back and forth twice. The plaques are equilibrated for 30 minutes under test conditions (temperature and humidity) but without loading. Then the test weight is hung on, producing a shearing stress parallel to the bond plane, and a measurement is made of the time taken for the bond to fail. If a holding time of 10 000 minutes is reached the experiment is discontinued before the adhesive bond fails.

### Microshear Travel μS1

A strip of the PSA tape, 1 cm wide, is adhered to a polished steel plaque (test substrate) over a length of 5 cm; this is done by applying the strip and using a 2 kg roller to roll over it back and forth three times. Double-sided adhesive tapes are lined on the reverse with a 50 μm aluminium foil. The test strip is reinforced with a PET film 190 μm thick and then cut off flush using a fixing device. The edge of the reinforced test strip projects 1 mm beyond the edge of the steel plaque. The plaques are equilibrated for 15 minutes under test conditions (40° C., 50% relative humidity) in the measuring instrument but without loading. Then the 500 g test weight is hung on, producing a shearing stress parallel to the bond plane. A micro-travel recorder records the shear travel in graph form as a function of time.

The microshear travel μS1 reported is the shear path after a weight load over 15 minutes. After the 15-minute measurement period under weight load, the weight is carefully removed from the sample and then relaxation is observed for a further 15 minutes. After 15 minutes without a weight load (relaxation) the microshear travel μS2 is determined. The two measurements are used to give the microshear travel ratio μS2/μS1. This ratio is a measure of the elasticity of the PSA.

The intention of the text below is to illustrate the invention by means of a number of examples, without wishing thereby to restrict the invention unnecessarily.

### EXAMPLES

### Example 1

A reactor conventional for a radical polymerization was charged with 8 kg of acrylic acid, 45 kg of n-butyl acrylate, 3 kg of t-butyl acrylate and 60 kg of acetone. After nitrogen gas had been passed through the reactor for 45 minutes with stirring the reactor was heated to 58° C. and 20 g of azoisobutyronitrile (AIBN, Vazo 6®, DuPont) were added. Subsequently the external heating bath was heated to 75° C. and the reaction was carried out constantly at this external temperature. After a reaction time of 1 h a further 20 g of AIBN were added. After 3 h and 6 h the mixture was diluted with 10 kg of acetone/isopropanol (97:3) each time. In order to reduce the residual initiators after 8 h and after 10 h portions of 100 g of bis-(4-tert-butylcyclohexanyl) peroxydicarbonate (Perkadox 16®, Akzo Nobel) were added. The reaction was terminated after a reaction time of 22 h and the reaction mixture was cooled to room temperature.

After the polymerization the polymer was diluted with isopropanol to a solids content of 25% and then blended with 0.3% by weight of polyisocyanate (Desmodur N 75, Bayer) with stirring. Subsequently the polymer solution was coated using a comma bar onto both sides of a polyester carrier with a thickness of 50 μm which beforehand had been coated with 1 g/m² per side of polyvinyl dichloride-acrylonitrile copolymer (Saran, Dow Chemicals). Drying took place at 120° C. for 10 minutes. The coat weight per side was 12 g/m². After the first coating step the adhesive was lined with a release paper.

### Example 2

A reactor conventional for a radical polymerization was charged with 28 kg of acrylic acid, 292 kg of 2-ethylhexyl acrylate, 40 kg of methyl acrylate and 300 kg of acetone/isopropanol (97:3). After nitrogen gas had been passed through the reactor for 45 minutes with stirring the reactor was heated to 58° C. and 0.2 kg of azoisobutyronitrile (AIBN, Vazo 64®, DuPont) was added. Subsequently the external heating bath was heated to 75° C. and the reaction was carried out constantly at this external temperature. After a reaction time of 1 h a further 0.2 kg of AIBN was added. After 3 h and 6 h the mixture was diluted with 150 kg of acetone/isopropanol (97:3) each time. In order to reduce the residual initiators after 8 h and after 10 h portions of 0.4 kg of bis-(4-tert-butylcyclohexanyl) peroxydicarbonate (Perkadox 16®, Akzo Nobel) were added. The reaction was terminated after a reaction time of 22 h and the reaction mixture was cooled to room temperature.

After the polymerization the polymer was diluted with isopropanol to a solids content of 25% and then blended with 0.4% by weight of aluminium(III) acetylacetonate with stirring. Subsequently the polymer solution was coated using a comma bar onto both sides of a polyester carrier with a thickness of 50 μm which beforehand had been corona-pretreated. Drying took place at 120° C. for 10 minutes. The coat weight per side was 12 g/m². After the first coating step the adhesive was lined with a release paper.

### Example 3

A PSA solution as in Example 2 was coated using a comma bar onto a printed polyester carrier which was 50 μm thick and had been corona-pretreated beforehand and coated on the other side with a polyvinyl stearylcarbamate release varnish. Drying took place at 120° C. for 10 minutes. The coat weight per side was 12 g/m².

| | Example 1 | Example 2 | Example 3 |
|---|---|---|---|
| PSA | All-acrylate | All-acrylate | All-acrylate |
| PSA coat weight per | 12 | 12 | 12 |
| side [g/m²] | | | |
| Total thickness of | 73 | 74 | 61 |
| PSA tape or release | | | |
| film [μm] | | | |
| K value 25° C. of the | 74 | 62 | 62 |
| PSA | | | |
| [Pa * s] | | | |
| Glass transition | 0 | −5 | −5 |
| temperature of the | | | |
| PSA [° C.] | | | |
| Microshear travel | 23 | 49 | 51 |
| 500 g, 40° C. [μm] | | | |
| Ratio μS2/μS1 | 0.15 | 0.19 | 0.18 |
| Shear strength at | >10 000 | >10 000 | >10 000 |
| 70° C. [min] | | | |
| Bond strength to steel | 2.5 | 3.5 | 3.2 |
| [N/cm] | | | |
| Bond strength to PET | 1.0 | 1.3 | 1.2 |
| [N/cm] | | | |
| Cutting tests | Minimal | Slight adhesive | Slight adhesive |
| (8000 cuts) | adhesive | residues after | residues after |
| | residues after | 8000 cuts | 8000 cuts |
| | 8000 cuts | | |

### COUNTEREXAMPLES

### Counterexample 1

Counterexample 1 is the commercial product tesa ® 4980. This is a double-sided PSA tape composed of a 12 μm PET carrier material coated on both sides with 34 g/m² of a resin-modified acrylate PSA.

### Counterexample 2

The PSA tape is produced as described in Example 1. The carrier film employed is a 25 μm PET film. The PSA used is that described in Example 2, with a coat weight of 50 g/m² per side.

### Counterexample 3

Counterexample 3 is the commercial product tesa ® 4972. This is a double-sided PSA tape composed of a 12 μm PET carrier material coated on both sides with 18 g/m² of a resin-modified acrylate PSA.

### Counterexample 4

Counterexample 4 is the commercial product Scotch ® 415 from 3M. This is a double-sided PSA tape composed of a 50 μm PET carrier material coated on both sides with 25 g/m² of an all-acrylate PSA.

| | Counter- | Counter- | Counter- | Counter- |
|---|---|---|---|---|
| | example 1 | example 2 | example 3 | example 4 |
| PSA | Acrylate, resin- | All-acrylate | Acrylate, | All-acrylate |
| | modified | | resin-modified | |
| PSA coat weight per | 34 | 50 | 18 | 25 |
| side [g/m²] | | | | |
| Total thickness of | 80 | 125 | 48 | 100 |
| PSA tape or release | | | | |
| film [μm] | | | | |
| K value 25° C. of the | 57 | 62 | 57 | Unknown |
| PSA | | | | |
| [Pa * s] | | | | |
| Glass transition | 5 | −5 | 5 | −4 |
| temperature of the | | | | |
| PSA [° C.] | | | | |
| Microshear travel μS1 | 470 | 52 | 195 | 550 |
| 500 g, 40° C. [μm] | | | | |
| Ratio μS2/μS1 | 0.31 | 0.19 | 0.32 | 0.35 |
| Shear strength at | 1278 | >10 000 | 1322 | 1269 |
| 70° C. [min] | | | | |
| Bond strength to steel | 8.3 | 5.3 | 7.0 | 2.7 |
| [N/cm] | | | | |
| Bond strength to PET | 6.5 | 4.2 | 5.3 | 2.2 |
| [N/cm] | | | | |
| Cutting tests | Severe adhesive | Adhesive | Severe adhesive | Severe |
| (8000 cuts) | residues; | residues; | residues; | adhesive |
| | termination after | termination | termination after | residues; |
| | 2000 cuts | after 4500 cuts | 3000 cuts | termination after |
| | | | | 2000 cuts |

1. Pressure-sensitive adhesive tape for medical diagnostic strips used to analyze biological fluids, the tape comprising a carrier material coated on one or both sides with not more than 20 g/m² of a pressure-sensitive adhesive, wherein the shear strength of the pressure-sensitive adhesive at 25° C. and 70° C. under a weight load of 1000 g is greater than 10,000 min and the polymer or polymers of the pressure-sensitive adhesive has or have a K value of greater than 55 Pa*s.

2. Pressure-sensitive adhesive tape according to claim 1, wherein the pressure-sensitive adhesive is composed of one or more copolymers in which acrylate monomers form the principal constituent.

3. Pressure-sensitive adhesive tape according to claim 1, wherein the polymers of the pressure-sensitive adhesive have a K value of greater than 60 Pa*s.

4. Pressure-sensitive adhesive tape according to claim 1, wherein the microshear travel of the pressure-sensitive adhesive tape after 15 minutes at 40° C. under a load of 500 g is less than 100 μm.

5. Pressure-sensitive adhesive tape according to claim 1, wherein the ratio of the microshear travels, μS2/μS1, is less than 0.3.

6. Pressure-sensitive adhesive tape according to claim 1, wherein the dynamic glass transition temperature of the pressure-sensitive adhesive at 10 rad/s is −10° C. to 15° C.

7. Pressure-sensitive adhesive tape according to claim 1, wherein the pressure-sensitive adhesive contains no additions at all of tackifier resins or plasticizers.

8. Pressure-sensitive adhesive tape according to claim 1, wherein the total thickness of the pressure-sensitive adhesive tapes without release film is 20 to 150 μm.

9. Pressure-sensitive adhesive tape according to claim 1, having a bond strength to steel of at least 1.5 and/or the bond strength to PET of at least 0.5.

11. Pressure-sensitive adhesive tape according to claim 1, wherein said carrier material is composed of PET.

12. Pressure-sensitive adhesive tape according to claim 1, comprising an adhesion promotor between the carrier material and the pressure-sensitive adhesives.

13. Diagnostic strips for analysis of biological fluids, comprising the pressure sensitive adhesive tape of claim 1.

14. The pressure-sensitive adhesive tape of claim 1, wherein said coating on one or both sides of said carrier material is in an amount of not more than 15 g/m².

15. The pressure-sensitive adhesive tape of claim 4, wherein said microshear travel is less than 60 μm.

16. The pressure-sensitive adhesive tape of claim 15, wherein said microshear travel is less than 30 μm.

17. The pressure-sensitive adhesive tape of claim 5, wherein said ratio of microshear travels is less than 0.2.

18. The pressure-sensitive adhesive tape of claim 6, wherein said dynamic glass transition temperature is −6° C. to 4 ° C.

19. The pressure-sensitive adhesive tape of claim 8, wherein said thickness is 50 to 100 μm.

20. The pressure-sensitive adhesive tape of claim 9, wherein said bond strength to steel is at least 2.5 N/cm and said bond strength to PET is at least 1.0 N/cm.
